(19) United States
(12) Patent Application Publication
(10) Pub. No.: US 2021/0213884 A1
(43) Pub. Date: Jul. 15, 2021

(54) RUNNING BOARD AND FORMING METHOD

(71) Applicant: Ford Global Technologies, LLC, Dearborn, MI (US)

(72) Inventors: Paul Kenneth Dellock, Northville, MI (US); Stuart C. Salter, White Lake, MI (US); Harry Lobo, Canton, MI (US); David Brian Glickman, Southfield, MI (US); Talat Karmo, Waterford, MI (US)

(21) Appl. No.: 16/740,599

(22) Filed: Jan. 13, 2020

(51) Int. Cl. B60R 3/00; B32B 1/08; B32B 15/08; B32B 27/08; B32B 27/20; B32B 7/12; B32B 37/15

(52) U.S. Cl. CPC B60R 3/002; B32B 1/08; B32B 15/08; B32B 27/08; B32B 27/20; B32B 2605/08; B32B 37/15; B32B 2305/08; B32B 2305/30; B32B 2451/00; B32B 2597/00; B32B 7/12

(57) ABSTRACT

A vehicle running board assembly includes, among other things, a tubular support member extending longitudinally along an axis. The tubular support member is formed of a reinforced polymer-based material. The assembly further includes a bonding layer formed of an unfilled polymer-based material. The bonding layer is disposed along a radially outer surface of the tubular support member. The assembly further includes a decorative film secured directly to a radially outer surface of the bonding layer.

### TECHNICAL FIELD

This disclosure relates generally to a vehicle running board and, more particularly, to a running board formed of extruded structures and having a decorative film.

### BACKGROUND

Many vehicles, in particular, Sport Utility Vehicles (SUVs) and trucks, include running boards. A user can step on a surface of the running board to assist with entering or exiting the vehicle.

### SUMMARY

A vehicle running board assembly according to an exemplary aspect of the present disclosure includes, among other things, a tubular support member extending longitudinally along an axis. The tubular support member is formed of a reinforced polymer-based material. The assembly further includes a bonding layer formed of an unfilled polymer-based material. The bonding layer is disposed along a radially outer surface of the tubular support member. The assembly further includes a decorative film secured directly to a radially outer surface of the bonding layer.

Another example of the foregoing assembly includes a step pad secured directly adjacent to the bonding layer or the tubular support member.

In another example of any of the foregoing assemblies, the step pad includes an anchoring stem and a tread. The anchoring stem extends from the tread through the tubular support member and the bonding layer.

In another example of any of the foregoing assemblies, the anchoring stem further extends through the outer layer.

In another example of any of the foregoing assemblies, the step pad is an extruded structure disposed directly on a radially outer surface of the bonding layer.

In another example of any of the foregoing assemblies, the tubular support member is formed of a glass-filled or fiber-filled polymer-based material.

In another example of any of the foregoing assemblies, the bonding layer is formed of a neat resin material.

In another example of any of the foregoing assemblies, the tubular support member, the bonding layer, and the decorative film are each extruded structures.

In another example of any of the foregoing assemblies, the tubular support member, the bonding layer, and the decorative film are constituents of a vehicle running board assembly.

In another example of any of the foregoing assemblies, the decorative film is disposed along an outboard side of the tubular support member, and along an upper side of the tubular support member.

In another example of any of the foregoing assemblies, the decorative film includes a transparent protective layer, at least one metallic layer, and an adhesive layer.

In another example of any of the foregoing assemblies, the bonding layer completely circumferentially surrounds the tubular support member.

A vehicle running board forming method according to another exemplary aspect of the present disclosure includes, among other things, extruding a tubular support member. The tubular support member is formed of a reinforced polymer-based material. The tubular support member extends longitudinally along an axis. The method further includes extruding a bonding layer over a radially outer surface of the tubular support member. The bonding layer is formed of an unfilled polymer-based material. The method further includes extruding a decorative film over a radially outer surface of the bonding layer.

Another example of the foregoing method includes machining to provide an aperture that extends radially through the tubular support member and the bonding layer. The method then includes the step of securing a step pad by extending an anchoring stem of the step pad through the aperture such that an enlarged head of the step pad is disposed within an interior of the tubular support member, and such that a tread of the step pad is disposed radially outside the tubular support member.

Another example of any of the foregoing methods includes extruding a step pad directly on a radially outer surface of the bonding layer.

In another example of any of the foregoing methods, the reinforced polymer-based material of the tubular support member is a glass-filled or fiber-filled polymer-based material, and the unfilled polymer-based material of the bonding layer is a neat polymer.

In another example of any of the foregoing methods, the decorative film includes a transparent protective layer, at least one metallic layer, and an adhesive layer.

In another example of any of the foregoing methods, the bonding layer completely circumferentially surrounds the tubular support member.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a rear perspective view of a vehicle.

FIG. 2 illustrates a perspective view of a running board assembly of the vehicle of FIG. 1 according to a first exemplary embodiment of the present disclosure.

FIG. 3 illustrates a section view taken at line 3-3 in FIG. 2.

FIG. 4 illustrates a close-up, section view of a decorative film of the running board assembly of FIG. 2.

FIG. 5 illustrates a perspective view of a running board assembly according to a second exemplary embodiment of the present disclosure.

FIG. 6 illustrates a section view taken at line 6-6 in FIG. 5.

FIG. 7 illustrates a perspective view of a running board assembly according to a third exemplary embodiment of the present disclosure.

FIG. 8 illustrates a section view taken at line 8-8 in FIG. 6.

### DETAILED DESCRIPTION

This disclosure relates generally to a vehicle running board assembly that includes a decorative film. The decorative film is secured to an unfilled polymer-based bonding layer of the running board assembly. The bonding layer covers portions of a reinforced polymer-based tubular support of the running board assembly. Securing the decorative film to the bonding layer rather than the tubular support member can, among other things, help to improve an appearance of the decorative film by reducing the chance of read-through.

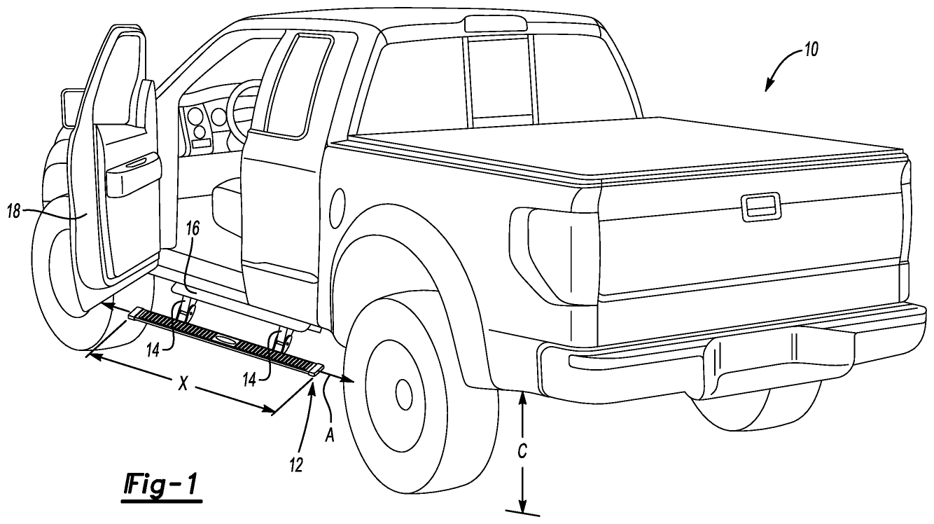

Referring to FIG. 1, a vehicle 10 has a relatively high clearance C, which is a distance between a ground surface and a floor of the vehicle 10. As shown, the vehicle 10 is a truck. While a truck is pictured, this disclosure is also applicable to sport utility vehicles (SUVs) and other types of vehicles, especially vehicles having a relatively high clearance C.

The vehicle 10 includes a running board assembly 12. Brackets 14 couple the running board assembly 12 to a vehicle body 16, which includes a frame and paneling of the vehicle 10. The running board assembly 12 extends longitudinally along an axis A. The running board assembly 12 has an axial length X that at least spans a width of a door 18 of the vehicle 10.

The running board assembly 12, in some examples, can be a retractable running board assembly that is movable between the deployed position shown and a retracted position. While a retractable running board assembly is shown in FIG. 1, it should be understood that this disclosure extends to running board assemblies that are not retractable. That is, it should be understood that the running board assembly 12 could instead be a running board assembly that is stationary (i.e., single, deployed position only).

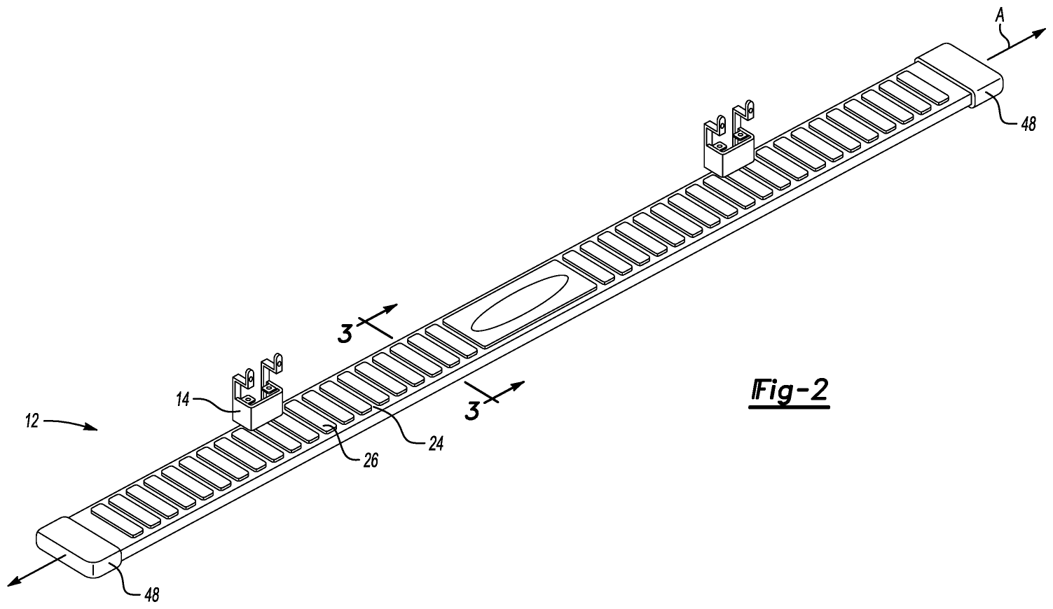

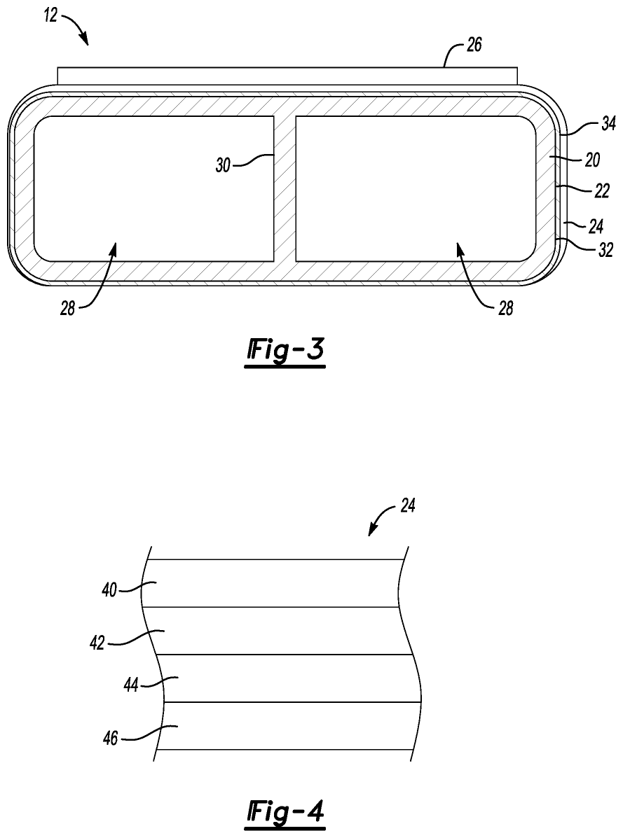

With reference now to FIGS. 2 and 3, the running board assembly 12 includes a tubular support member 20, a bonding layer 22, a decorative film 24, and at least one step pad 26. The tubular support member 20, the bonding layer 22, and the decorative film 24 extend longitudinally along the axis A. The at least one step pad 26, in the exemplary embodiment, includes a plurality of individual step pads disposed along the axis A at positions axially spaced from one another.

The tubular support member 20 is formed of a reinforced polymer-based material. In an exemplary embodiment, the tubular support member 20 is formed of a glass-filled polymer-based material. The base material of the reinforced polymer-based material can be polypropylene, for example. Other exemplary base materials could be nylon or polyester.

In another example, the tubular support member is formed of a fiber-filled polymer-based material. Other example fillers include carbon and basalt. The tubular support member 20 could be formed with a combination of filler materials, such as a glass and fiber fillers.

The tubular support member 20 is an extruded structure. That is, the tubular support member 20 is formed via an extrusion process. A person having skill in this art and the benefit of this disclosure would be able to structurally distinguish a tubular structure, such as the tubular support member 20, from a structure that is not extruded, such as a structure that is cast rather than extruded.

The tubular support member 20 includes open areas 28 separated from each other by a support rib 30. The tubular support member 20 has a radially outer surface 32 that extends circumferentially continuously about the axis A.

The bonding layer 22 is disposed along the radially outer surface 32 of the tubular support member 20 and is secured to the tubular support member 20. In the exemplary embodiment, the bonding layer 22 completely circumferentially surrounds the tubular support member 20 such that the tubular support member 20 is sleeved within the bonding layer 22.

Like the tubular support member 20, the bonding layer 22 is an extruded structure. In an exemplary coextrusion process, the tubular support member 20 is first extruded. The bonding layer 22 is then coextruded over the radially outer surface 32 of the tubular support member 20 while the tubular support member 20 is still heated.

The bonding layer 22 is formed of an unfilled polymer-based material. In an exemplary embodiment, the material of the bonding layer 22 is the same as the base material of the tubular support member 20. The bonding layer 22, as it lacks the fillers of the tubular support member 20, can be considered a neat resin material. As the bonding layer 22 lacks a filler, the bonding layer 22 provides a smooth radially outer surface 34 to which the decorative film 24 is attached.

In the exemplary embodiment, the decorative film 24 is disposed along an outboard side of the tubular support member 20 and along an upper side of the tubular support member 20. These sides of the running board assembly 12 are more visible than the inboard side and the lower side.

Like the tubular support member 20 and the bonding layer 22, the decorative film 24 is an extruded structure. The decorative film 24 can be extruded over the radially outer surface 34 of the bonding layer 22 after extruding the bonding layer 22 over the tubular support member 20.

As the decorative film 24 is extruded over the relatively smooth radially outer surfaces of the bonding layer 22, rather than surfaces of the tubular support member 20, the filler material within the tubular support member 20 is less likely to read-through the decorative film 24.

The decorative film 24 can provide a decorative appearance to the running board assembly 12. Referring now to FIG. 4 with continuing reference to FIGS. 2 and 3, the decorative film 24, in the exemplary embodiment, is a multi-layer film that includes a protective layer 40, a decorative layer 42, a base layer 44, and an adhesive layer 46. In other examples, the decorative film 24 is foil, a stretched polyester film, a painted layer, or a metalized film.

The protective layer 40 of the exemplary decorative film 24 can be optically clear. In an exemplary embodiment, the protective layer 40 is a polyester. The protective layer 40 can provide both environmental protection, such as protection against UV rays, salt, and impact damage due to stones or debris. The protective layer 40 can further facilitate image depth and a high gloss look.

The decorative layer 42 can be a vacuum metalized film. The decorative layer 42, in another embodiment, could comprise multiple layers of metal, such as aluminum, nickel, copper, silver, or chrome. The decorative layer 42 could also be a painted film.

The base layer 44 can be a polymer such as polyester. Other examples could use other materials for the base layer 44 that are compatible with a painting or plating technology.

The adhesive layer 46 can be an adhesive or compatibilizing layer. The adhesive layer 46 ensures a good bond between the decorative film 24 and the radially outer surface 34 of the bonding layer 22.

While the decorative film 24 could completely circumferentially surround the bonding layer 22, extruding the decorative film 24 on the upper surface and outboard surface of the running board assembly 12 can provide some material and cost savings. The bonding layer 22, which is exposed and visible on the bottom side and inboard side of the running board assembly 12, can be molded in a desired color.

Generally, a method of forming the vehicle running board assembly 12 includes a step of first extruding the tubular support member 20 from the reinforced polymer-based material. Next, the method extrudes the bonding layer 22 over at least a portion of the radially outer surface 32 of the tubular support member 20. A graining wheel could then be used to add grain to selected areas of the bonding layer 22. The decorative film 24 is then extruded over at least a portion of the radially outer surface 34 of the bonding layer 22. A pressure roller could be used to wet out the decorative film 24 to the bonding layer 22. After which, the coextruded structures can be cooled in a water tank and cut to a desired longitudinal length.

To complete the exemplary running board assembly 12, the step pads 26 are injection molded, and then secured to the upper surface of the running board assembly 12. In the exemplary embodiment, the step pads 26 are directly secured to the upper surface of the running board assembly 12. End caps 48 can then be added to opposing axial ends of the running board assembly 12 to conceal the open areas and ends of the tubular support member 20, the bonding layer 22, and the decorative film 24.

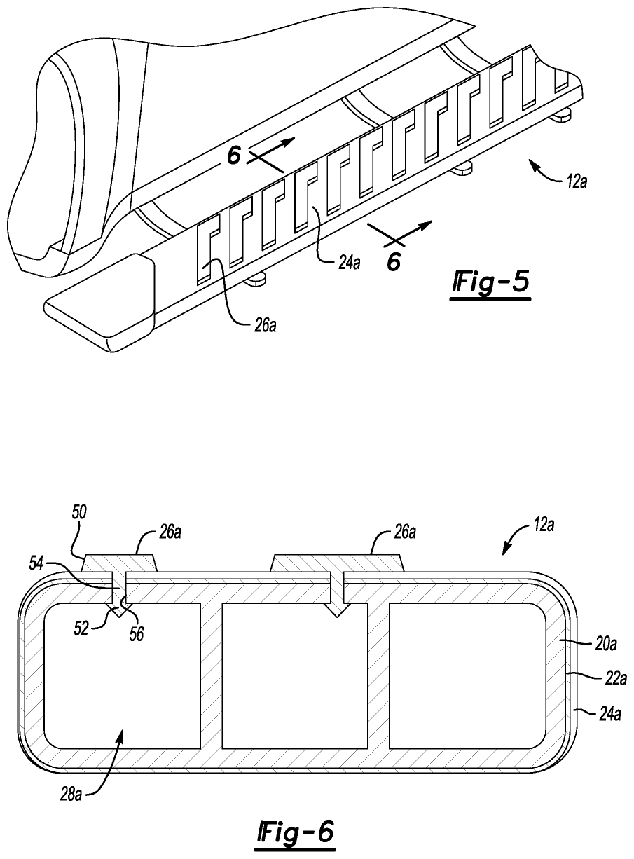

With reference now to FIGS. 5 and 6, a running board assembly 12a according to another exemplary aspect of the present disclosure includes a tubular support member 20a, a bonding layer 22a, a decorative film 24a, and a plurality of step pads 26a.

In this exemplary embodiment, the step pads 26a include a tread portion 50, an enlarged head 52, and an anchoring stem 54 extending from the tread portion 50 to the enlarged head 52. The step pads 26 are secured to the running board assembly 12a by inserting the enlarged head 52 through an aperture 56. The aperture 56 extends through the decorative film 24a, the bonding layer 22a, and the tubular support member 20a. A machining process such as drilling could be utilized to form the apertures 56 utilized to hold the step pads 26a.

The enlarged head 52 is compressed as the enlarged head 52 is moved through the aperture 56. The enlarged head 52 is moved through the aperture 56 until the enlarged head 52 is positioned within an open area 28a of the tubular support member 20a. At this point, the enlarged head 52 expands outward to prevent withdrawal of the anchoring stem 54 from within the aperture 56. This holds the step pad 26 in the installed position shown in FIGS. 5 and 6.

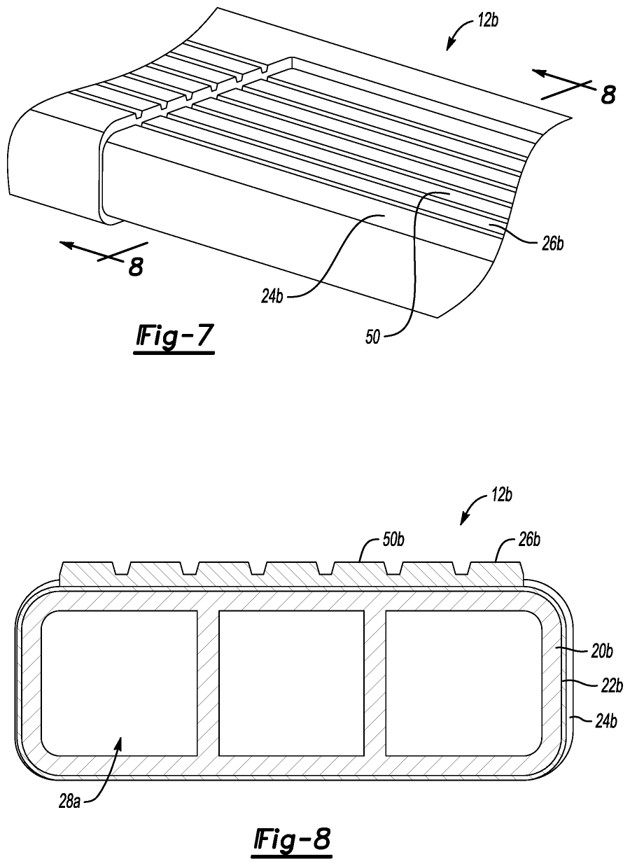

With reference now to FIGS. 7 and 8, a running board assembly 12b, according to another exemplary embodiment, includes a tubular support member 20b, a bonding layer 22b, a decorative film 24b, and a plurality of step pads 26b.

In this exemplary embodiment, the step pads 26b are an extruded structure that is extruded directly on a radially outer surface of the bonding layer 22b along an upper surface of the running board assembly 12b. The decorative film 24b covers the bonding layer 22b along a radially outer edge of the running board assembly 12b.

As the step pad 26b is an extruded structure, treads 50b of the step pads 26b extend along the longitudinal axis of the running board assembly 12b. As the step pads 26b are extruded, a grain wheel could be utilized to roll a grain on the step pads 26b.

Features of the disclosed embodiments include a running board assembly provided by coextruding a layer of substantially neat resin over areas of a reinforced polymer-based material. The layer of neat resin creates a relatively smooth surface to which a decorative film can be extruded or otherwise attached.

The decorative film can provide a metal plated or painted appearance with little or no read-through of the fillers of the tubular-based member. The appearance of the running board assembly can be changed by utilizing different films without substantial changes to tooling. As the running board assembly is extruded, different running board longitudinal lengths of running boards can be provided using substantially the same set of tools, which can reduce costs and provide design flexibility when compared to forming techniques such as blow molding.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A vehicle running board assembly, comprising:
a tubular support member extending longitudinally along an axis, the tubular support member formed of a reinforced polymer-based material;
a bonding layer formed of an unfilled polymer-based material, the bonding layer disposed along an radially outer surface of the tubular support member; and
a decorative film secured directly to a radially outer surface of the bonding layer.

2. The vehicle running board assembly of claim 1, further comprising at least one step pad secured directly adjacent to the bonding layer or the tubular support member.

3. The vehicle running board assembly of claim 2, wherein the at least one step pad includes an anchoring stem and a tread, the anchoring stem extending from the tread through the tubular support member and the bonding layer.

4. The vehicle running board assembly of claim 3, wherein the anchoring stem further extends through the outer layer.

5. The vehicle running board assembly of claim 2, wherein the at least one step pad is an extruded structure disposed directly on a radially outer surface of the bonding layer.

6. The vehicle running board assembly of claim 1, wherein the tubular support member is formed of a glass-filled or fiber-filled polymer-based material.

7. The vehicle running board assembly of claim 1, wherein the bonding layer is formed of a neat resin material.

8. The vehicle running board assembly of claim 1, wherein the tubular support member, the bonding layer, and the decorative film are each extruded structures.

9. The vehicle running board assembly of claim 1, wherein the tubular support member, the bonding layer, and the decorative film are constituents of a vehicle running board assembly.

10. The vehicle running board assembly of claim 1, wherein the decorative film is disposed along an outboard side of the tubular support member, and along an upper side of the tubular support member.

11. The vehicle running board assembly of claim 1, wherein the decorative film includes a transparent protective layer, at least one metallic layer, and an adhesive layer.

12. The vehicle running board assembly of claim 1, wherein the bonding layer completely circumferentially surrounds the tubular support member.

13. A vehicle running board forming method, comprising:
extruding a tubular support member, the tubular support member formed of a reinforced polymer-based material, the tubular support member extending longitudinally along an axis;
extruding an bonding layer over a radially outer surface of the tubular support member, the bonding layer formed of an unfilled polymer-based material; and
extruding a decorative film over a radially outer surface of the bonding layer.

14. The vehicle running board forming method of claim 13, further comprising machining to provide an aperture that extends radially through the tubular support member and the bonding layer, and securing at least one step pad by extending an anchoring stem of the at least one step pad through the aperture such that an enlarged head of the at least one step pad is disposed within an interior of the tubular support member, and a tread of the at least one step pad is disposed radially outside the tubular support member.

15. The vehicle running board forming method of claim 13, further comprising extruding at least one step pad directly on a radially outer surface of the bonding layer.

16. The vehicle running board forming method of claim 13, wherein the reinforced polymer-based material of the tubular support member is a glass-filled or fiber-filled polymer-based material and the unfilled, polymer-based material of the bonding layer is a neat polymer.

17. The vehicle running board forming method of claim 13, wherein the decorative film includes a transparent protective layer, at least one metallic layer, and an adhesive layer.

18. The vehicle running board forming method of claim 13, wherein the bonding layer completely circumferentially surrounds the tubular support member.
